(19) United States
(12) Patent Application Publication
(10) Pub. No.: US 2006/0285171 A1
(43) Pub. Date: Dec. 21, 2006

(54) Method of performing fax in next generation network

(76) Inventors: Haiyin Ma, Guangdong Province (CN); Ming Lin, Guangdong Province (CN); Xiang Yu, Guangdong Province (CN); Yun Ma, Guangdong Province (CN); Xiaoli Jiang, Guangdong Province (CN); Dongsheng Jiang, Guangdong Province (CN)

Correspondence Address: MCDERMOTT WILL & EMERY LLP, 600 13TH STREET, N.W., WASHINGTON, DC, 20005-3096, US

(21) Appl. No.: 10/554,958

(22) PCT Filed: Nov. 8, 2004
(86) PCT No.: PCT/CN04/01266

§ 371 Date: Oct. 28, 2005

(30) Foreign Application Priority Data
Nov. 28, 2003 (CN) 200310120016.8
Dec. 16, 2003 (CN) 200310124105.X

(51) Int. Cl. H04N 1/00

(52) U.S. Cl. 358/400; 358/500

(57) ABSTRACT

The invention discloses a method of implementing a fax in a next generation network, comprising steps of: either of two media gateways notifying a media gateway controller upon detection of a Fax Start signal when they communicate with each other; the media gateway controller sending in parallel a Modify command to the media gateways at the two ends of the communication based upon a negotiated fax codec mode, so as to modify the codec mode; the media gateways at the two ends modifying the codec mode based upon the Modify command, returning a Reply message to the media gateway controller, and starting a fax. The invention can reduce time for a fax switching and improve success ratio of a fax negotiation.

### FIELD OF THE INVENTION

The invention relates to the field of communication technology, particularly to a method of implementing fax in a Next Generation Network (NGN).

### BACKGROUND OF THE INVENTION

The Next generation network (NGN) is developing continuously. As shown in FIG. 1, in a NGN architecture, the Media Gateway Controller (MGC)/soft switch on a control layer is separated from the Media Gateways (MGs) on an access layer. The MGC controls the MGs through a packet protocol to accomplish relaying of calls and establishment of media streams (voice and video). In the standard NGN architecture, the media streams between MGs are also based on packet networks, which is different to the case that they are based on conveyance of time division circuits in a conventional PSTN.

In order to provide fax services in the NGN network, there are the following two ways in the prior art.

One way is the transparent transmission approach, i.e. through G.711 codec. As shown in FIG. 2, the MGC communicates with the MGs through a Media Gateway Control Protocol (H.248 or MGCP). The MGC is responsible for controlling those calling statuses related with the MGs, and the MGs accomplish a conversion of media formats between different networks under the control of the MGC. Fax machines are connected to the corresponding MGs respectively. G.711 codec is employed in the IP network. G.711 is a codec standard performing 64 kbit/s PCM (Pulse Code Modulation) on the voice. During the transparent transmission, the code stream information at the narrow-band side is encapsulated in IP messages as it is, and is transmitted over Internet through a Real-Time Transmission Protocol (RTP). The transparent transmission largely depends on transmission quality of the IP network. When G.711 codec is used, the MGs have to adjust some parameters of gateway DSPs (Digital Signal Processors) according to the type of callings (e.g. fax, data, text or voice), so as to improve the transmission quality. Before the start of a fax, two fax machines have to negotiate with each other so as to use the same codec mode.

The other way is the T.38 approach. The T.38 protocol is a real-time IP fax transmission standard introduced by ITU-T (International Telecommunication Union). T.38 protocol defines a transmission process of fax systems between terminals in an IP network. Fax signals have to be first modulated by a voice/fax gateway and then transmitted in the form of IP fax packets over the IP network through TCP (Transmission Control Protocol) or UDP (User Datagram Protocol). As shown in FIG. 3, the MG parses negotiation signals and data signals between the fax machines and converts them to T.38 messages, and transmits the messages over Internet through RTP. The MG at the other side reproduces the original fax negotiation signals and the data signals from the T.38 messages. In comparison with the transparent transmission, T.38 codec used for implementing fax over IP can improve success ratio and quality of a fax.

In either of the above two ways, it is required to negotiate the fax codec mode. Since the negotiation for a fax is of end-to-end, then in the case of T.38, two MGs have to switch to the T.38 mode quickly; otherwise the probability of failed negotiation between the two fax machines will increase. Moreover, in the case of T.38, after a DSP (Digital Signal Processor) in some gateways is switched to the T.38 mode, the local port number of the DSP may change to be different from the voice port number prior to the switching. Thus, at the other end, a RTP Remote attribute has to be modified. Therefore, the MGC has to consider how to switch to the T.38 mode quickly.

FIG. 4 shows a flow diagram of the fax negotiation in the prior art. Only the voice codec mode is negotiated during a voice session. Upon detection of a fax tone, whether T.38 is supported is then negotiated. If T.38 is supported, the MGC first modifies the codec mode for one of the MGs (e.g. the MG2 in FIG. 3) to obtain a RTP Local attribute of the MG2, and then modifies the codec mode and a RTP Remote attribute for another MG (e.g. the MG1 in FIG. 3). If the RTP local port in the MG1 changes during the switching, the MGC has to notify the MG2 to modify the RTP Remote attribute. In the case of the H.248 media gateway control protocol, for example, the process is illustrated as following:

1. Through a negotiation of voice codec mode, the MGC sends an Add command to the MG1, and obtains a Local RTP endpoint attribute from an ADD Reply (a response) message.

2. The MGC sends an ADD command in which a Remote RTP endpoint attribute is included to the MG2, and obtains a Local RTP endpoint attribute from an ADD Reply message.

3. The MGC sends a Modify command to the MG1, so as to modify the Remote attribute of the RTP endpoint.

4. After a session between the both sides starts, a fax machine sends a “Fax Start” signal, and the MG1 detects the “Fax Start” signal and notifies the MGC through a Notify command.

5. Through a negotiation of a fax codec mode, the T.38 mode or the transparent transmission mode can be used. If the T.38 mode is determined to be used, the MGC sends a Modify command to MG2 so as to modify the codec mode to T.38. Since the local RTP port number of the MG2 may change, a new local RTP port number may be obtained in the Reply message.

6. The MGC sends a Modify command in which the Remote RTP attribute is included to the MG1 so as to modify the codec mode to T.38. If the local RTP port number of the MG2 changes, the Modify command will also modify the RTP Remote attribute of the MG1 at the same time. Since the local RTP port number of the MG1 may change, a new local RTP port number may be obtained in the Reply message.

7. The MGC stores the local RTP port number of the MG1 and the MG2, compares them with the Reply messages, and then becomes aware of whether the local RTP port numbers have changed or not. If the local RTP port number of the MG1 has changed, the MGC sends a Modify command to the MG2 so as to modify the RTP Remote attribute.

The drawback of the prior art is that, upon the detection of the “Fax Start” signal, the negotiation process of a fax codec mode and then at least two consecutive MODIFY operations are required before the complete switching to the T.38 mode. If the port number(s) of either one or two ends changes, at least three consecutive MODIFY operations will be required in order to switch to the T.38 mode. The time interval from occurrence of “Fax Start” event to completion of the switching is so long that the negotiation for the fax is often failed.

In addition, since voice is conveyed through IP in the NGN network, there are some factors such as time delay, compression or the like, which may result in signal distortion and thereby cause fax or MODEM failure while fax service or MODEM data service is conveyed. In order to solve the above problem, some relevant standardization organizations have established a T.38 and MOIP (MODEM OVER IP, i.e. conveying MODEM signals over an IP network) standard applicable to the above applications over the IP network. To employ such a standard, it is required to bear the MGs separated from services in the NGN, a fax or MODEM signal can be detected during a normal voice session, and the MGC (soft switch) can be reported to, so as to start a T.38 or MOIP process.

Signals that can identify a fax include CNG MONOTONE, CED, V21 FLAG, fax and data indications in CM signals (only supported by high speed fax machines), etc.

Signals that can identify MODEM include ANS (identical to CED) or /ANS (ANS with a phase reversal), fax and data indications in CM signals (only supported by high speed MODEMs), etc.

In the prior art, there are mainly the following two solutions for detection control of a fax signal and a MODEM:

Solution I: the MG judges that there occurs a fax or a MODEM upon detection of any signal, and then switches an IP connection of a voice channel to G.711 codec, which is a lossless compression, a transparent transmission fax or a MODEM signal.

This solution can neither meet requirements of a fax or a MODEM in terms of packet redundancy, JITTERBUFFER or the like, nor use protocols such as T.38, which are customized for a fax.

Solution II: the MG judges that there occurs a fax upon detection of a CNG monotone, and judges that there occurs a MODEM upon detection of any other signals first.

Since the CNG tone is a monotone used to prompt a subscriber a fax start. Such a audio is rather common, and furthermore the CNG monotone also exists in some MODEMs. Thus this solution may cause a miss-detection. For instance, in an experiment environment, a whistling is sometimes detected as a CNG monotone, thus resulting in interruption of a voice channel.

### SUMMARY OF THE INVENTION

The invention is aimed to overcome the drawback of a long negotiation time interval that often causes a failed negotiation in the prior art, and provides a method of implementing a fax in a NGN, which can reduce the time required for a fax switching and thus improve the success ratio of a fax negotiation.

Hereupon, the invention is also aimed to provide a method of implementing a fax in a NGN, which can detect a fax signal and a MODEM data service accurately, and thereby overcome the drawback of a low service quality due to an inaccurate judgment of a fax signal in the prior art.

To this end, the invention provides a method of implementing a fax in a next generation network, comprising steps of:

1) either of two media gateways notifying a media gateway controller upon detection of a Fax Start signal when they communicate with each other;

2) the media gateway controller sending in parallel a Modify command to the media gateways at the two ends of the communication based upon a negotiated fax codec mode, so as to modify the codec mode;

3) the media gateways at the two ends modifying the codec mode based upon the Modify command, returning a Reply message to the media gateway controller, and starting a fax.

Preferably in the step 3), if a local port number of one media gateway at one end changes during the modification of the codec mode, the media gateway controller sends the Modify command to the other media gateway at the opposite end based upon to the Reply message from the one media gateway, and the other media gateway at the opposite end modifies a RTP Remote attribute based upon the command Modify command and in turn starts the fax.

Preferably in the step 3), if local port numbers of both media gateways on the two ends change during the modification of the codec mode, information indicative of the change is included in the Reply message, the media gateway controller sends the Modify command simultaneously to the media gateways on the two ends based upon the Reply message, and the media gateways modify a RTP Remote attribute based upon the Modify command and in turn start the fax.

Preferably in the step 1), the media gateways negotiate a fax codec mode along with a voice codec mode prior to the detection of the “Fax Start” signal during the communication between them.

Preferably the negotiation further comprises steps of: the calling media gateway controller sending supported voice codec modes and fax codec modes to the called media gateway controller at the same time; the called media gateway controller determining the voice codec mode and the fax codec mode based upon its supported voice codec modes and fax codec modes and strategy of choice; and the called media gateway controller notifying the calling media gateway controller of the chosen voice codec mode and fax codec mode.

Preferably the fax codec modes include G.711 codec or T.38 codec.

Preferably in the step 1), the process that establishment of a link between the media gateways prior to the detection of the Fax Start signal comprises steps of:

a) the media gateway controller sending an Add command to a first media gateway, and obtaining a Local RTP endpoint attribute of the first media gateway from the Reply message of the first media gateway;

b) the media gateway controller sending an Add command in which the Remote RTP endpoint attribute to a second media gateway, and obtaining a Local RTP attribute of the second media gateway from the Reply message of the second media gateway;

c) the media gateway controller sending the Modify command to the first media gateway which in turn modifies the Remote RTP endpoint attribute; and

d) the two media gateways establishing the link and communicating with each other after the modification.

Preferably in the step 1), the detection of the Fax Start signal further comprises steps of:

A) the media gateway reporting the detected subscriber event signal to the media gateway controller;

B) the media gateway controller judging the subscriber event signal as following:
B1) if the subscriber event signal is a CM signal, further judging a parameter indicative of service data in the CM signal; if the parameter indicates DATA, determining the subscriber event as starting a MODEM; and if the parameter indicates FAX, determining the subscriber event as starting a fax; and
B2) if the subscriber event signal is an ANS or CED signal, further judging whether any CNG signal has been received; if yes, determining the subscriber event as starting a fax, otherwise determining the subscriber event as starting a MODEM; and

C) the media gateway controller switching a voice channel between the media gateways based upon the subscriber event signal; if the subscriber event is to start a fax, going to step 2); and if the subscriber event is to start a MODEM, switching the voice channel between the media gateways to the MOIP mode.

Preferably the judgment in the step B) further comprises step of judging the subscriber event as starting a fax if the subscriber event signal is a V21FLAG signal.

Preferably the judgment in the step B) further comprises step of judging the subscriber event as starting a MODEM if the subscriber event signal is an ANS signal with a phase reversal.

Compared to the prior art, the invention has advantages in that, in the invention, the negotiation of the fax codec mode is not performed in the process from the detection of the “Fax Start” signal to the completion of the switching; instead, the command for modification of the codec mode is sent in parallel based upon the negotiated fax codec mode, so in the case of the port numbers unchanged during the switching of the codec mode, the two consecutive MODIFY commands in the prior art can be replaced by one parallel MODIFY command, thus reducing the time interval from the occurrence of the “Fax Start” event to the completion of the switching, and improving success ratio of the fax negotiation.

In addition, in the invention, in the case of the port numbers changed during the switching of the codec mode, the three consecutive MODIFY commands in the prior art can be replaced by at most two parallel MODIFY commands, which also facilitate reduction of the time interval from the occurrence of the “Fax Start” event to the completion of the switching.

Moreover, the invention can prevent any mistaken or failed report of a fax and MODEM through a reliable judgment of a subscriber event signal, enabling the NGN to bear services better.

### BRIEF DESCRIPTION OF THE DRAWINGS

FIG. 1 is an illustration of the NGN architecture;

FIG. 2 is a schematic diagram of implementing a fax in a transparent transmission;

FIG. 3 is a schematic diagram of implementing a fax using T.38;

FIG. 4 is a flow diagram of a fax negotiation in the prior art;

FIG. 5 is a flow diagram of a fax negotiation according to the invention; and

FIG. 6 is a flow diagram of detecting fax signal according to the invention.

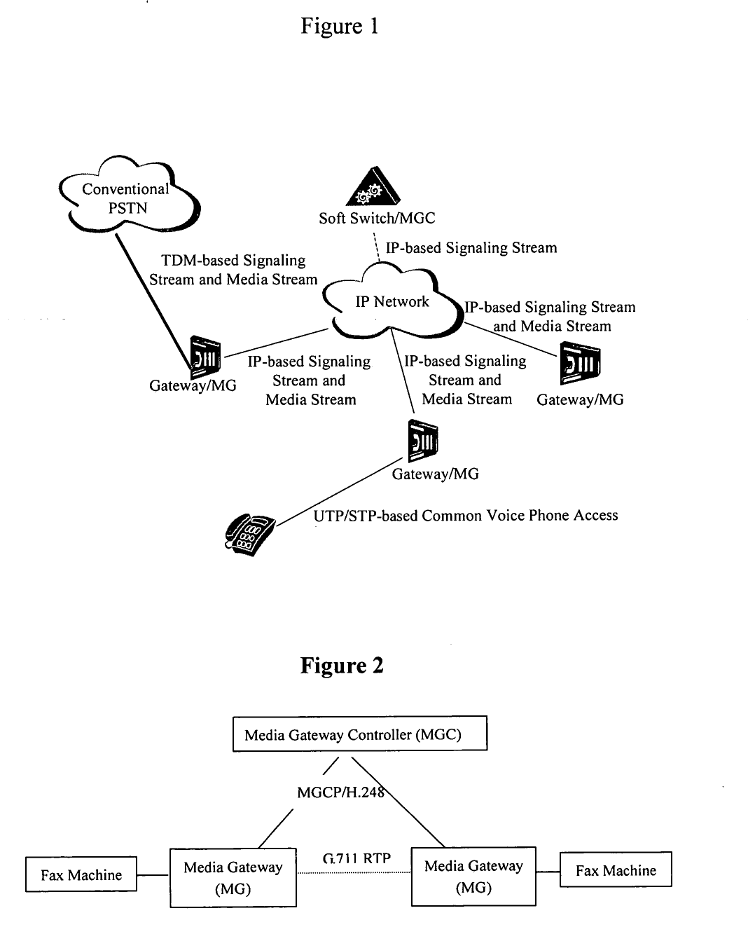

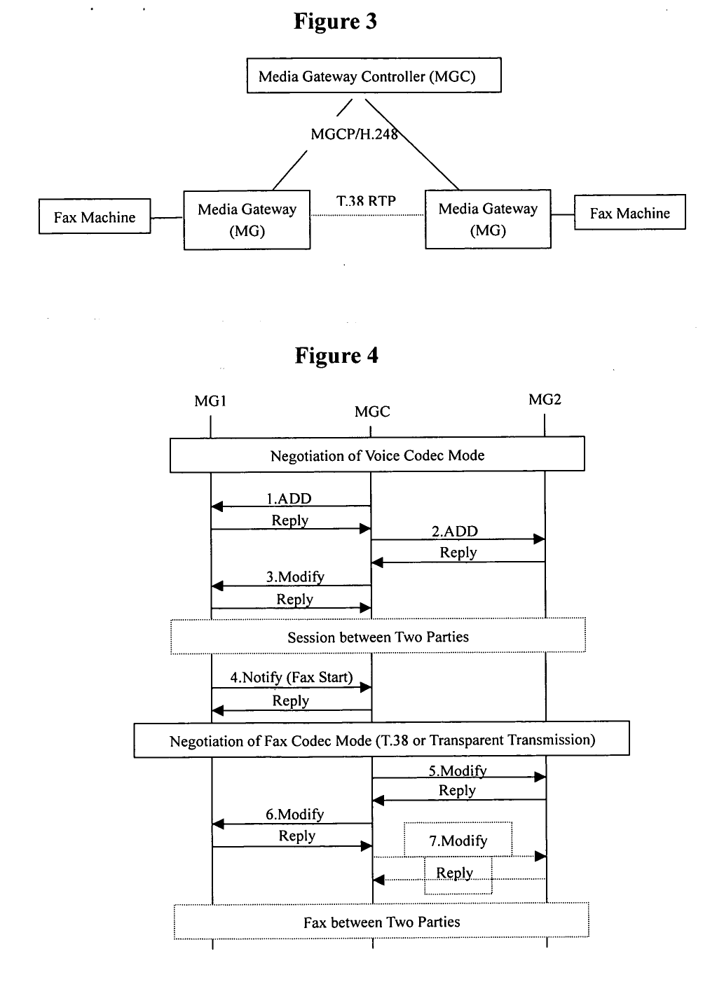

### DETAILED DESCRIPTION OF THE EMBODIMENTS

An embodiment of the invention will be further detailed with reference to the embodiments and the drawings.

The embodiment attains the object of reducing fax switching time and improving success ratio of a fax negotiation by optimizing the process of the fax negotiation. During a voice session, codec modes for the voice and the fax are negotiated at the same time, and thus the codec mode negotiation process for the fax is advanced ahead, and the required time interval from the detection of a “Fax Start” signal to the completion of the codec modes switching is reduced. If T.38 is supported, commands for modification of the codec mode are sent to the two sides of the communication in parallel and simultaneously upon the detection of a fax tone. If the local port number of any MG has changed during the modification of the codec mode, the MGC sends a Modify command to the other MG at the opposite end so as to modify the RTP Remote attribute. If the local port numbers of both MGs have changed during the modification of the codec mode, the MGC sends a Modify command simultaneously to the MGs at the both ends so as to modify the RTP Remote attributes.

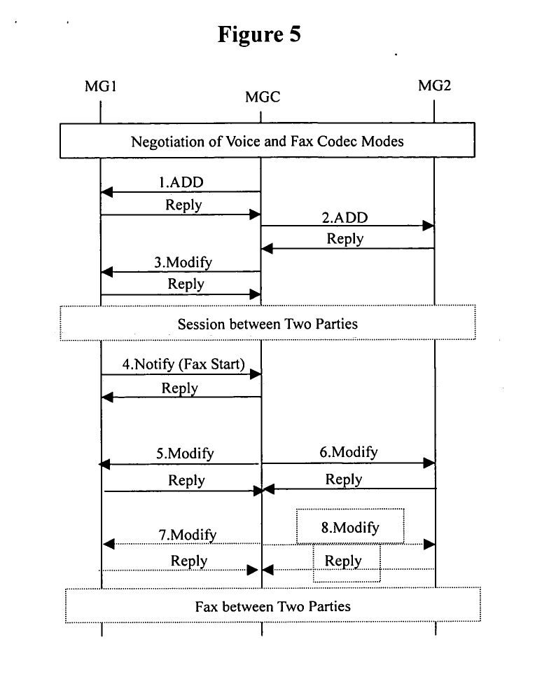

FIG. 5 shows the flow diagram of a fax negotiation in the embodiment as following (taking H.248 for example):

1. During the voice session, codec modes for the voice and the fax are negotiated at the same time, and the codec mode for the fax may be T.38 or the transparent transmission.

The fundamental principle of the negotiation for a voice codec mode is that, the calling MGC sends all supported voice codec modes to the called MGC (if the calling party and the called party are in the same MGC, the negotiation is done internally in the MGC), and the called MGC determines a voice codec mode based upon its supported codec capabilities and strategy of choice and notifies the calling MGC. Simultaneous negotiation of voice and fax codec modes means that the calling party covers all supported fax codec modes during the negotiation for a codec mode of a voice session. The called party chooses a fax codec mode based upon its supported fax codec modes and strategy of choice, and covers the chosen fax codec mode while notifying the calling party of the voice codec mode.

In this embodiment, T.38 is used for the fax codec. The MGC sends an Add command to the MG1, and obtains a Local RTP endpoint attribute from an ADD Reply message.

2. The MGC sends an ADD command in which a Remote RTP endpoint attribute is included to the MG2, and obtains a Local RTP endpoint attribute from an ADD Reply message.

3. The MGC sends a Modify command to the MG1 so as to modify the Remote attribute of the RTP endpoint.

4. After the session between the two parties starts, the fax machine sends a “Fax Start” signal, and the MG1 detects the signal and notifies the MGC with a Notify command.

5. Since the fax codec mode is T.38, the MGC sends a Modify command to MG1 so as to modify the codec mode to T.38. Since the port number are required to change after the switching to T.38 for some DSPs, a new local RTP port number may be obtained from the Reply message.

6. Meanwhile, the MGC sends a Modify command to MG2 so as to modify the codec mode to T.38, and a new local RTP port number may be also obtained from the Reply message.

7. The MGC stores the local RTP port numbers of the MG1 and the MG2, and compares them with the received Reply message, so as to determine whether the local RTP port numbers have changed or not. If the local RTP port number of the MG2 has changed, the MGC sends a Modify commands to the MG1 so as to modify the RTP Remote attribute.

8. If the local RTP port number of the MG1 has changed, the MGC sends a Modify message to the MG2 so as to modify the RTP Remote attribute.

For the case in which the fax codec mode is switched to T.38, the port numbers may change. In the above steps 7 and 8, if the local port of any MG has changed, the MGC will send a Modify command to the other MG at the opposite end so as to modify the RTP Remote attribute, and in turn a fax starts. If the port numbers of both MGs have changed, the MGC sends a Modify command in parallel to the MGs at the both ends so as to modify the RTP Remote attributes, and in turn a fax starts.

For the case in which the fax codec mode is switched to the G.711 transparent transmission, the local RTP port numbers of the MG1 and the MG2 will usually keep unchanged. Then, after the above step 4, the MGC sends a Modify command to the MG1 and the MG2 in parallel so as to modify the codec mode to G.711, and in turn a fax starts between the two parties. In that way, only one parallel Modify command will be required to complete a switching process of codec modes after the start of a fax signal.

In comparison with the prior art, the negotiation process of fax codec modes is omitted between the detection of the “Fax Start” and the completion of the switching according to the embodiment. In addition, for the case in which that the port numbers keep unchanged during the switching of codec modes, two consecutive MODIFY commands in the prior art are replaced by one parallel MODIFY command; and for the case in which the port numbers have changed during the switching of codec modes, three consecutive MODIFY commands in the prior art are replaced by at most two parallel MODIFY commands. Thus, the time interval from occurrence of a “Fax Start” event to completion of the switching can be reduced largely, and success ratio of a fax negotiation can be increased.

In the method of implementing a fax as described in the embodiment, it is required to detect a fax signal, and such a detection can be done with any solution in the prior art. In order to judge a fax signal accurately and thereby improve QoS, the embodiment further proposes an improved process for the detection.

When a subscriber under a MG starts a fax or a MODEM during a session, the MG need to detect a corresponding event and report it to a MGC (a soft switch). The MGC judges whether there occurs a MODEM or a fax based upon certain rules, and further switches an IP voice channel between the MGs to the T.38 or MOIP (MODEM OVER IP, i.e. conveying MODEM signals over an IP network) mode.

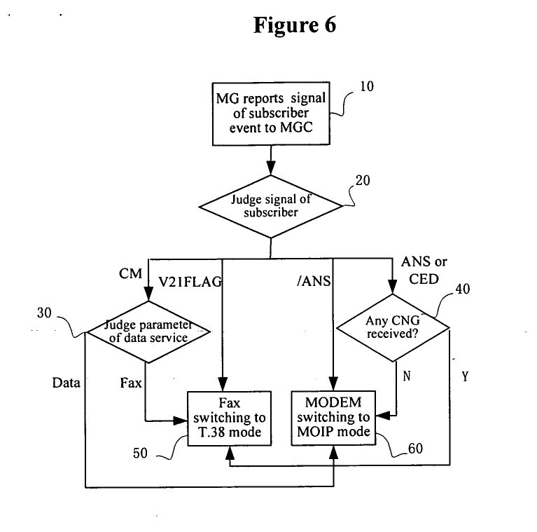

As shown in FIG. 6, the processing flow in the embodiment is as following:

Step 10: the MG reporting the detected event signal of the subscriber to the MGC.

Step 20: the MGC judging the event signal of the subscriber as following:
If the event signal of the subscriber is a CM signal, going to step 30;
If the event signal of the subscriber is an ANS or CED signal, going to step 40;
If the event signal of the subscriber is a V21FLAG signal, determining the subscriber event as a fax start and going to step 50;
If the event signal of the subscriber is an ANS signal with a phase reversal (i.e. /ANS), determining the subscriber event as a MODEM start and going to step 60.

Step 30: judging a parameter indicative of service data in the CM signal; if the parameter indicates DATA, determining the subscriber event as a MODEM start and going to step 60; and if the parameter indicates FAX, determining the subscriber event as a fax start and going to step 50.

Moreover, DATA is a parameter of the CM signal, which may be TEXT, DATA or FAX. DATA indicates a data service, and FAX indicates a fax service.

Step 40: judging whether a CNG signal has been received or not; if yes, determining the subscriber event as a fax start and going to step 50; otherwise determining the subscriber event as a MODEM start and going to step 60;

Step 50: the subscriber starting a fax, and the MGC switching the voice channel between the MGs to the T.38 mode.

Step 60: the subscriber starting a MODEM, and the MGC switching the voice channel between the MGs to the MOIP mode.

According to the embodiment, it is required that the MGs can detect V21, CM, ANS and CED signals. If it can not be ensured that the MGs are able to detect such events due to the DSPs, the MGs may report CNG signals as V21 and report other signals as CM (DATA) which are deemed as MODEM so as to ensure an uniform interface to the MGC.

The above description only covers some preferred embodiments of the embodiment. Those skilled in the art will appreciate that various modification, additions and substitutions are possible without departing from the principle of the invention, which also fall into the scope of the invention.

1. A method of implementing a fax in a next generation network, comprising steps of:
1) either of two media gateways notifying a media gateway controller upon detection of a Fax Start signal when they communicate with each other;
2) the media gateway controller sending in parallel a Modify command to the media gateways at the two ends of the communication based upon a negotiated fax codec mode, so as to modify the codec mode; and
3) the media gateways at the two ends modifying the codec mode based upon the Modify command, returning a Reply message to the media gateway controller, and starting a fax.

2. The method of claim 1, wherein in the step 3), if a local port of one media gateway at one end changes during the modification of the codec mode, the media gateway controller sends the Modify command to the other media gateway at the opposite end based upon to the Reply message from the one media gateway, and the other media gateway at the opposite end modifies a RTP Remote attribute based upon the Modify command and in turn starts the fax.

3. The method of claim 1, wherein in the step 3), if local ports of both media gateways on the two ends change during the modification of the codec mode, information indicative of the change is included in the Reply message, the media gateway controller sends the Modify command simultaneously to the media gateways on the two ends based upon the Reply message, and the media gateways modify a RTP Remote attribute based upon the Modify command and in turn start the fax.

4. The method of claim 3, wherein in the step 1), the media gateways negotiate a fax codec mode along with a voice codec mode prior to the detection of the “Fax Start” signal during the communication between the media gateways.

5. The method of claim 4, wherein the negotiation further comprises steps of:
the calling media gateway controller sending supported voice codec modes and fax codec modes to the called media gateway controller at the same time;
the called media gateway controller determining the voice codec mode and the fax codec mode based upon its supported voice codec modes and fax codec modes and strategy of choice;
and the called media gateway controller notifying the calling media gateway controller of the chosen voice codec mode and fax codec mode.

6. The method of claim 4, wherein the fax codec modes include G.711 codec or T.38 codec.

7. The method of claim 4, wherein in the step 1), the establishment of a link between the media gateways prior to the detection of the Fax Start signal by the media gateways comprises steps of:
a) after the negotiation of the voice codec and the fax codec, the media gateway controller sending an Add command to one of the media gateways, and obtaining a Local RTP endpoint attribute from the Reply message;
b) the media gateway controller sending an Add command in which the Remote RTP endpoint attribute to the other media gateway, and obtaining a Local RTP attribute from the Reply message;
c) the media gateway controller sending the Modify command to the first media gateway which in turn modifies the Remote RTP endpoint attribute; and
d) the two media gateways establishing the link and communicating with each other after the modification.

8. The method of claim 1, wherein in the step 1), the detection of the Fax Start signal further comprises steps of:
A) the media gateway reporting the detected subscriber event signal to the media gateway controller;
B) the media gateway controller judging the subscriber event signal as following:
B1) if the subscriber event signal is a CM signal, further judging a parameter indicative of service data in the CM signal; if the parameter indicates DATA, determining the subscriber event as starting a MODEM; and if the parameter indicates FAX, determining the subscriber event as starting a fax; and
B2) if the subscriber event signal is an ANS or CED signal, further judging whether any CNG signal has been received; if yes, determining the subscriber event as starting a fax, otherwise determining the subscriber event as starting a MODEM; and
C) the media gateway controller switching a voice channel between the media gateways based upon the subscriber event signal; if the subscriber event is to start a fax, going to step 2); and if the subscriber event is to start a MODEM, switching the voice channel between the media gateways to the MOIP mode.

9. The method of claim 8, wherein the judgment in the step B) further comprises step of judging the subscriber event as starting a fax if the subscriber event signal is a V21FLAG signal.

10. The method of claim 8, wherein the judgment in the step B) further comprises step of judging the subscriber event as starting a MODEM if the subscriber event signal is an ANS signal with a phase reversal.
